(19) United States
(12) Patent Application Publication
(10) Pub. No.: US 2026/0268343 A1
(43) Pub. Date: Sep. 10, 2026

(54) SYSTEMS AND METHODS FOR DYNAMICALLY ADJUSTING INSTITUTIONAL INTERACTIONS BASED ON A LOCATION ROUTINE FOR A USER DEVICE

(71) Applicant: Wells Fargo Bank, N.A., San Francisco, CA (US)

(72) Inventors: Zachary King, Charlotte, NC (US); John Andrew Chuprevich, Davidson, NC (US); Matthew N. Wheeler, Charlotte, NC (US); Daniel Sanford, Charlotte, NC (US)

(21) Appl. No.: 19/071,371

(22) Filed: Mar. 5, 2025

(51) Int. Cl. G06Q 30/018; G01S 5/02; G06Q 20/40; G06Q 30/02

(52) U.S. Cl. CPC G06Q 30/0185; G01S 5/0284; G06Q 20/4016; G06Q 30/0281

(57) ABSTRACT

Systems, apparatuses, methods, and computer program products are disclosed for adjusting institutional interactions with a customer based on user device location data. The example method includes receiving a location routine for a user device and current location of the user device. The example method further includes determining whether a deviation condition for a candidate deviation event type is satisfied based on the current location and the location routine. The example method further includes detecting the occurrence of a deviation event associated with a deviation event type in response to determining that the deviation condition for a candidate deviation event type is satisfied. The example method further includes updating a customer account associated with the user device based on the deviation event type, wherein updating the customer account comprises at least one of (a) applying an account restriction, and (b) modifying customer information within the customer account.

### BACKGROUND

Maintaining accurate and up-to-date customer account information is essential for customer account security and for keeping customer information safe and out of the hands of bad actors. Traditional systems rely on customers to update this information, which can lead to inaccuracies or security vulnerabilities within the customer account.

### BRIEF SUMMARY

Customer information for a customer account plays a critical role in maintaining security, fraud prevention, and personalized services for a customer. Such customer information is often collected by the entity that maintains the customer account during the account opening process. Customer information may include personal details, such as a residential address, employment information (e.g., an employer name, workplace address, workplace phone number, salary information, a job title, and/or the like), customer account activity (e.g., financial activity), etc. However, ensuring that this customer information remains accurate over time presents challenges, particularly as customers shift towards digital and paperless account management. Inaccurate or outdated information can lead to security vulnerabilities, misdirected communications, increased fraud risks, and various inefficiencies in service delivery.

Conventional approaches for updating customer information often rely on periodic prompts requesting customers to review and confirm their account details. These prompts are typically sent at fixed intervals, such as annually or semi-annually, and are entirely dependent upon customer engagement. Such conventional methods are passive, inflexible, and fail to capture real-time changes in customer information. These conventional methods further lack mechanisms to proactively detect changes in customer circumstances, such as changes in residence or employment, leading to prolonged periods where the customer information remains outdated. This can introduce various security risks, including unauthorized access and fraudulent activities, particularly when sensitive information, such as replacement bank cards, financial statements, or authentication credentials, is sent to an incorrect or outdated address.

In contrast to these conventional techniques for customer information management, example embodiments described herein provide a location-based system for automatically detecting deviations in user device location data that may indicate changes in customer information. By leveraging real-time location data (e.g., a current location of a user device) and predicted location data for the user device, example embodiments may dynamically assess patterns in movement of a user device and identify anomalies that may signal a change in key customer information details. Instead of relying solely on periodic customer engagement, example embodiments proactively identify and prompt customers to confirm updates in response to detected deviation events. In some embodiments, the customer information may automatically be updated in response to detecting a deviation event, thereby reducing the reliance on customer action while maintaining customer information accuracy.

In some embodiments, machine learning techniques may be applied to refine the predictive accuracy of a location routine for a user device over time. In particular, a user device routine machine learning model may be trained using location data received by the user device over time. The user device routine machine learning model may then generate a location routine for the user device that is representative of the movement pattern of the user device over time. In some embodiments, the accuracy of the location routine may be evaluated to ensure that the predicted locations over corresponding time windows remain accurate and up to date. If an accuracy score fails to satisfy an accuracy score threshold, the user device routine machine learning model may be retrained using a fresh plurality of location data received from the user and an updated location routine may be generated and stored for use. This ensures that the location routine for a user device is dynamically updated based on evolving movement patterns.

Example embodiments represent a significant improvement over traditional methods by reducing reliance on manual customer updates, increasing customer account security through real-time anomaly/deviation detection, and ensuring that the customer account reflects the most current and accurate customer information. In doing so, example embodiments enhance the overall system operational efficiency by reducing the number of customer service inquiries associated with changes in customer information, thereby allowing personnel to focus on higher priority tasks. Additionally, the system may reduce mail-related inefficiencies, such as undeliverable correspondence, returned items, and misdirected bank cards. Example embodiments may further enable entities to comply with various regulatory requirements related to data accuracy and/or fraud prevention while reducing the administrative burden of manual data validation processes.

Accordingly, the present disclosure describes a system that automates the detection of deviation events using user device location data to facilitate secure, accurate, and efficient customer account management. Through real-time location analysis and intelligent response mechanisms, example embodiments improve account security, reduce fraud risks, and ensure that customer accounts reflect up-to-date and verified information. By integrating responsive deviation event detection with customer account management, example embodiments enhance both security and the customer experience by providing proactive customer account updates while minimizing disruptions to legitimate customer activities.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2A illustrates a schematic block diagram of example circuitry embodying a system device that may perform various operations, in accordance with some example embodiments described herein.

FIG. 2B illustrates a schematic block diagram of example circuitry embodying a user device that may perform various operations, in accordance with some example embodiments described herein.

FIG. 3 illustrates an example flowchart for dynamically adjusting institutional interactions with a customer based on user device location data, in accordance with some example embodiments described herein.

FIG. 4 illustrates an example flowchart for determining when to update a machine learning model, in accordance with some example embodiments described herein.

FIG. 5 illustrates an example flowchart for updating a customer account for an out-of-bounds travel deviation event type, a rapid location change deviation event type, a high-risk location deviation event type, and/or a customer account activity deviation event type, in accordance with some example embodiments described herein.

FIG. 6 illustrates an example flowchart for updating a customer account for a residential relocation deviation event type, in accordance with some example embodiments described herein.

FIG. 7 illustrates an example flowchart for updating a customer account for a workplace change deviation event type, in accordance with some example embodiments described herein.

FIG. 8 illustrates an example flowchart for the sending of location data from the user device, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers, programmable automation controllers, industrial computers, desktop computers, personal data assistants, laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as “mobile devices.”

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “user device” refers to a personal computing device. For example, a mobile phone, laptop computer, smartwatch, or tablet computer.

### System Architecture

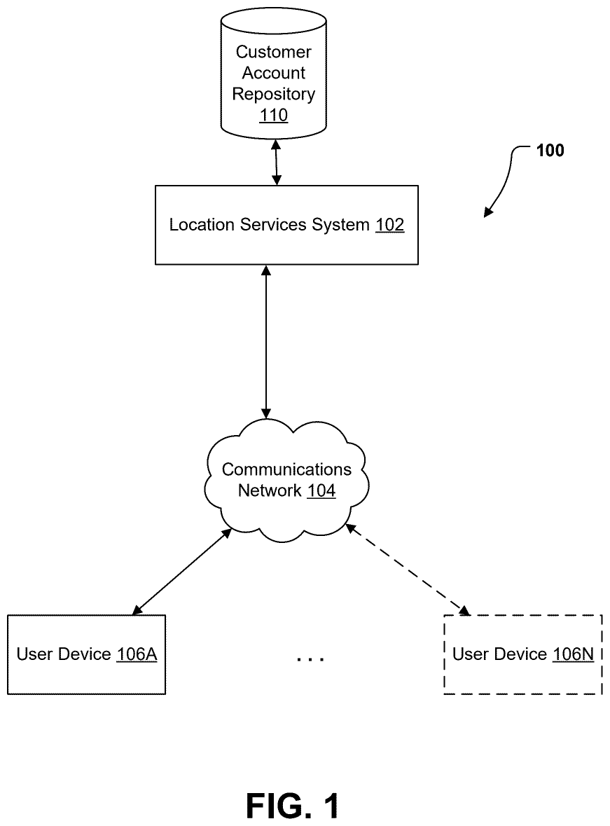

Example embodiments described herein may be implemented using any of a variety of computing devices or servers. To this end, FIG. 1 illustrates an example environment 100 within which various embodiments may operate. As illustrated, a location services system 102 may receive and/or transmit information via a communications network 104 (e.g., the Internet) with any number of other devices, such as one or more of the user devices 106A-106N.

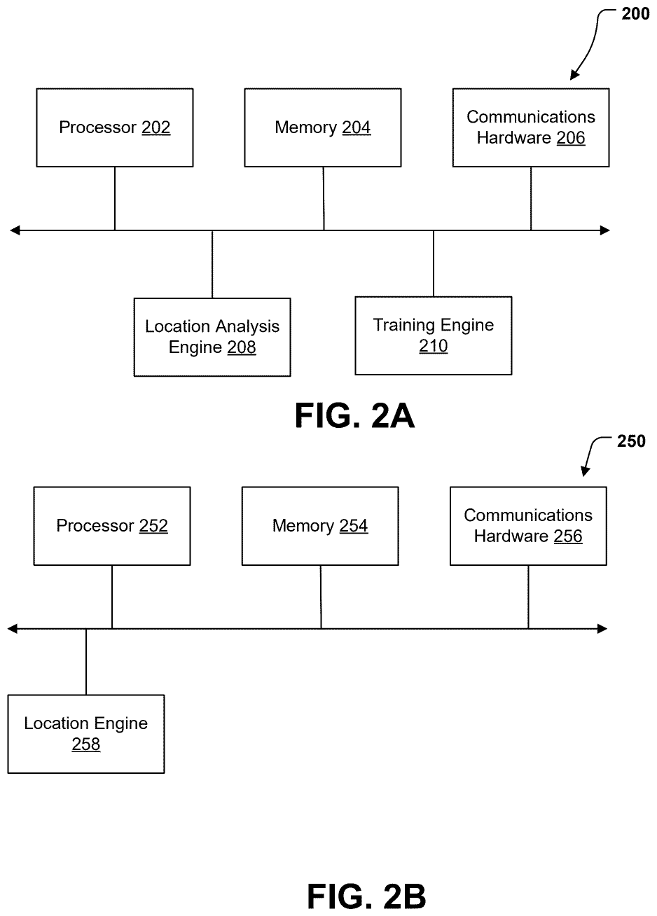

The location services system 102 may be implemented as one or more computing devices or servers, which may be composed of a series of components. Particular components of the location services system 102 are described in greater detail below with reference to the apparatus 200 in connection with FIG. 2A.

In some embodiments, the location services system 102 further includes a customer account repository 110 that comprises a distinct component from other components of the location services system 102. The customer account repository 110 may be embodied as one or more direct-attached storage devices (such as hard drives, solid-state drives, optical disc drives, or the like) or may alternatively comprise one or more network-attached storage devices independently connected to a communications network (e.g., the communications network 104). The customer account repository 110 may host the software executed to operate the location services system 102. The customer account repository 110 may store information relied upon during operation of the location services system 102, such as various account information and customer information that may be used by the location services system 102, data and documents to be analyzed using the location services system 102, or the like. In addition, the customer account repository 110 may store control signals, device characteristics, and access credentials enabling interaction between the location services system 102 and one or more of the user devices 106A-106N.

The one or more user devices 106A-106N may be embodied by any computing devices known in the art (e.g., mobile phone, personal computer). The one or more user devices 106A-106N need not themselves be independent devices but may be peripheral devices communicatively coupled to other computing devices. In some embodiments, a user device (e.g., any one of the user devices 106A-106N) may be associated with a customer who is associated with a customer account maintained by the location services system 102.

### Example Implementing Apparatuses

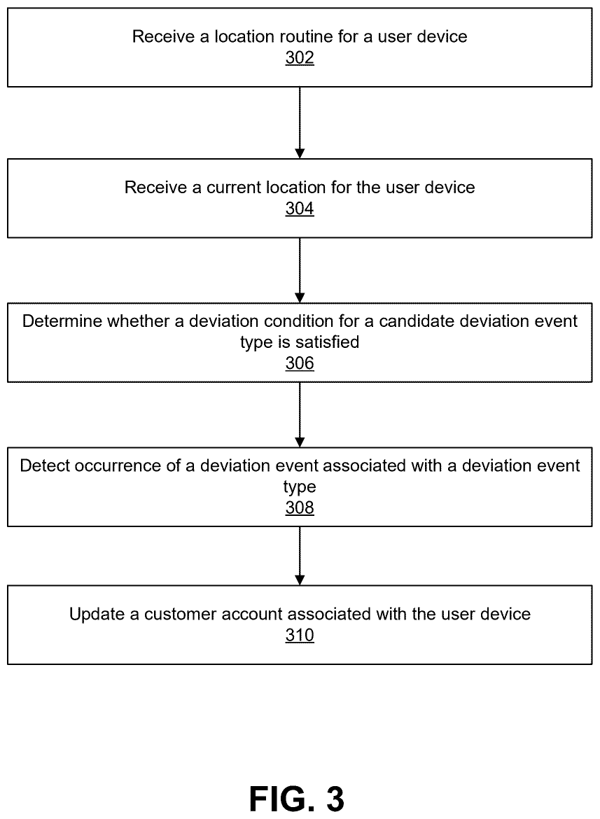

The location services system 102 (described previously with reference to FIG. 1) may be embodied by one or more computing devices or servers, shown as the apparatus 200 in FIG. 2A. The apparatus 200 may be configured to execute various operations described above in connection with FIG. 1 and below in connection with FIGS. 3-7. As illustrated in FIG. 2A, the apparatus 200 may include the processor 202, the memory 204, the communications hardware 206, the location analysis engine 208, and the training engine 210, each of which will be described in greater detail below.

The processor 202 (and/or co-processor or any other processor assisting or otherwise associated with the processor) may be in communication with the memory 204 via a bus for passing information among components of the apparatus 200. The processor 202 may be embodied in a number of different ways and may, for example, include one or more processing devices configured to perform independently. Furthermore, the processor 202 may include one or more processors configured in tandem via a bus to enable independent execution of software instructions, pipelining, and/or multithreading. The use of the term “processor” may be understood to include a single-core processor, a multi-core processor, multiple processors of the apparatus 200, remote or “cloud” processors, or any combination thereof.

The processor 202 may be configured to execute software instructions stored in the memory 204 or otherwise accessible to the processor 202. In some cases, the processor 202 may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, software instructions, or the like for enabling the apparatus 200 to carry out various functions in accordance with example embodiments contemplated herein.

The communications hardware 206 may be any means, such as a device or circuitry embodied in either hardware or a combination of hardware and software, that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a customer and, in some embodiments, to receive an indication of customer input. In this regard, the communications hardware 206 may comprise a customer interface, such as a display, and may further comprise the components that govern use of the customer interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these customer interface elements through software instructions (e.g., application software and/or system software, such as firmware) stored on a memory (e.g., the memory 204) accessible to the processor 202.

In addition, the apparatus 200 further comprises a location analysis engine 208, which may be configured to determine whether a deviation condition for a candidate deviation event type is satisfied, detect the occurrence of a deviation event, and update a customer account. In some embodiments, the location analysis engine 208 may generate an accuracy score for a location routine.

Further, the apparatus 200 further comprises a training engine 210 that trains a user device routine machine learning model with a first plurality of location data, wherein the user device routine machine learning model is used by the location analysis engine 208 to determine the type of customer deviation event and the second plurality of location data relates to locations of detected customer account activity. In some embodiments, the training engine 210 may be further configured to train the user device routine machine learning model using at least the first plurality of location data and the second plurality of location data, wherein the first and second plurality of location data are location data received from the user device (e.g., the user device 106A). The training engine 210 may utilize the processor 202, the memory 204, or any other hardware component included in the apparatus 200 to perform these operations, as described in connection with FIGS. 3-7 below. The training engine 210 may further utilize the communications hardware 206 to gather data from a variety of sources (e.g., the user devices 106A-106N and/or the customer account repository 110, as shown in FIG. 1) and/or exchange data with a customer.

Although components 202-210 are described in part using functional language, it will be understood that the particular implementations necessarily include the use of particular hardware. It should also be understood that certain of these components 202-210 may include similar or common hardware. For example, the location analysis engine 208 and the training engine 210 may each at times leverage use of the processor 202, the memory 204, or the communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the location analysis engine 208 and the training engine 210 may leverage the processor 202, the memory 204, or the communications hardware 206 as described above, it will be understood that any of the location analysis engine 208 and the training engine 210 may include one or more dedicated processors, specially configured field-programmable gate array (FPGA), or application-specific integrated circuit (ASIC) to perform its corresponding functions, and it may accordingly leverage the processor 202 executing software stored in a memory (e.g., the memory 204) or communications hardware 206 for enabling any functions not performed by special-purpose hardware. In all embodiments, however, it will be understood that the location analysis engine 208 and the training engine 210 comprise particular machinery designed for performing the functions described herein in connection with such elements of the apparatus 200.

Having described specific components of example apparatus 200, example embodiments are described below in connection with a series of flowcharts.

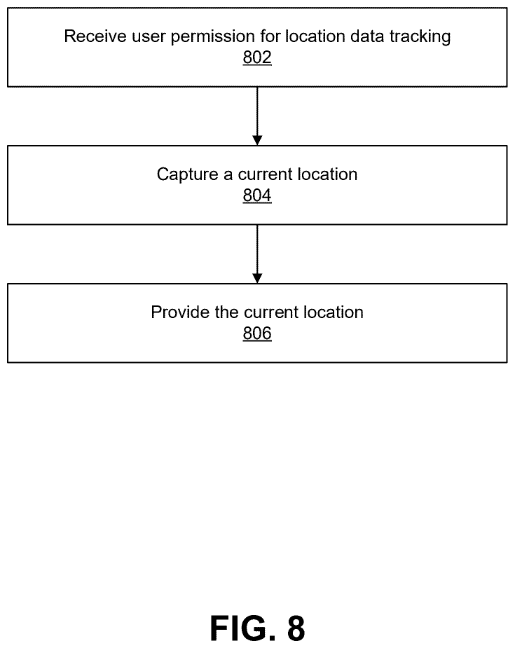

As illustrated in FIG. 2B, an apparatus 250 is shown that represents an example user device (e.g., any one of the user devices 106A-106N). The apparatus 250 includes the processor 252, the memory 254, and the communications hardware 256, and may optionally include the location engine 258, which includes hardware components designed for determining the customer's location. The location engine 258 may utilize the processor 252, the memory 254, or any other hardware component included in the apparatus 250 to perform these operations, as described in connection with FIG. 8 below. The location engine 258 may further utilize the communications hardware 256 to send the location data to the apparatus 200.

It will be understood that the location engine 258 may include one or more dedicated processors, specially configured FPGA, or ASIC to perform its corresponding functions, and it may accordingly leverage the processor 252 executing software stored in a memory (e.g., the memory 254) or the communications hardware 256 for enabling any functions not performed by special-purpose hardware. In all embodiments, however, it will be understood that the location engine 258 comprises particular machinery designed for performing the functions described herein in connection with such elements of the apparatus 250.

In some embodiments, various components of the apparatuses 200 and 250 may be hosted remotely (e.g., by one or more cloud servers) and thus need not physically reside on the corresponding apparatus 200 or 250. For instance, some components of the apparatus 200 may not be physically proximate to the other components of apparatus 200. Similarly, some or all of the functionality described herein may be provided by third-party circuitry. For example, a given apparatus 200 may access one or more third-party circuitries in place of local circuitries for performing certain functions.

As will be appreciated based on this disclosure, example embodiments contemplated herein may be implemented by an apparatus 200 or 250. Furthermore, some example embodiments may take the form of a computer program product comprising software instructions stored on at least one non-transitory computer-readable storage medium (e.g., the memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by the apparatus 200 as described in FIG. 2A or the apparatus 250 as described in FIG. 2B, that loading the software instructions onto a computing device or apparatus produces a special-purpose machine comprising the means for implementing various functions described herein.

### Example Operations of the Location Services System

Turning to FIGS. 3-7, example flowcharts are illustrated that contain example operations implemented by example embodiments described herein. The operations illustrated in FIGS. 3-7 may, for example, be performed by the location services system 102 shown in FIG. 1, which may in turn be embodied by the apparatus 200, which is shown and described in connection with FIG. 2A. To perform the operations described below, the apparatus 200 may utilize one or more of the processor 202, the memory 204, the communications hardware 206, the location analysis engine 208, the training engine 210, and/or any combination thereof.

Turning first to FIG. 3, example operations are shown for dynamically adjusting institutional interactions with a customer based on user device location data. User device location may relate to anomalous customer behavior. Anomalous customer behavior may refer to changes in a customer's detected regular routine (e.g., location routine). The location routine for a user device may include location data and a time window associated with each location. Detection of anomalous customer behavior may lead to changes in customer account access, based on the classification of the deviation event type detected from the location routine. In some embodiments, example operations may automatically update customer information for a corresponding customer, thereby reducing the reliance on customers to manually update this information. Advantageously, in addition to improving the accuracy of stored customer information, example embodiments also strengthen account security by preventing sensitive information from being disclosed to unintended recipients, thereby reducing the risk of data exposure. Furthermore, example embodiments restrict provision of correspondence containing sensitive information during periods when customers are unavailable (e.g., while traveling), thereby ensuring secure and timely correspondence delivery.

As shown by operation 302, the apparatus 200 includes means, such as the communications hardware 206 or the like, for receiving a location routine for a user device. In some embodiments, the communications hardware 206 may receive the location routine from an external device and/or from a user device routine machine learning model. In some embodiments, the communications hardware 206 may retrieve the location routine from an associated memory, such as the memory 204, or an associated repository, such as the customer account repository 110. The location routine for a user device, such as the user device 106A, may include a pattern of movement or behavior of the user device 106A. More particularly, a location routine may define predicted locations for corresponding time windows for the user device 106A. In some embodiments, the location routine may further include a predicted customer account activity for a predicted location. A location routine may define frequently visited locations, travel routes, time-based movement patterns, etc. In some embodiments, the location routine may be a structured dataset or data object that may be analyzed by the location analysis engine 208.

In some embodiments, the location analysis engine 208 may use a user device routine machine learning model to generate the location routine based on a first plurality of location data collected from the user device 106A. In some embodiments, the user device routine machine learning model is an unsupervised machine learning model. In some embodiments, the training engine 210 may train the user device routine machine learning model using the first plurality of location data. In some embodiments, the training engine 210 may generate a training dataset based on the first plurality of location data. In some embodiments, the user device routine machine learning model may use clustering techniques (e.g., k-means clustering, density-based spatial clustering of applications with noise, and/or Gaussian mixture models), sequence-based analysis (e.g., hidden Markov models, long short-term memory networks, and/or Markov chains), or anomaly detection techniques (e.g., isolation forests) to generate a location routine. The user device routine machine learning model may optimize parameters using unsupervised learning objectives, such as clustering metrics (e.g., silhouette score), transition accuracy, and/or prediction error (e.g., mean squared error). The user device routine machine learning model may output the location routine to the location analysis engine 208. In some embodiments, the location analysis engine 208 may store the location routine in an associated memory, such as the memory 204, in an associated storage repository, such as the customer account repository 110, and/or in association with the customer account.

Through the training process, the user device routine machine learning model may learn to detect patterns of movement for the user device associated with the first plurality of location data. The first plurality of location data may include one or more location data point. A location data point may include location data (e.g., global positioning system (GPS) coordinates, Internet Protocol (IP) address, or the like), any corresponding customer account activity, and a time stamp for when the location data point was collected by the user device 106A. For example, the location data points for the user device 106A may indicate the user device 106A is located at a location in uptown Charlotte associated with a café between 8:00 a.m.-9:00 a.m. and at a location in uptown Charlotte associated with a business between 9:00 a.m.-5:00 p.m. After 5:00 p.m., the location data points may indicate that the user device 106A is traveling to reach a location in the Charlotte suburbs where the user device 106A is then located at from 6:00 p.m.-7:00 a.m. The user device 106A may repeat this schedule from Monday to Friday, and the user device routine machine learning model may detect this pattern of movement for the user device 106A and generate a location routine based on the user device location.

Optionally, in some embodiments, the user device routine machine learning model may also detect corresponding customer account activity at a location. For example, in some embodiments, the location analysis engine 208 may provide the location routine, which may include the location of the café, the usual time window the customer typically visits, and the usual spending activity (e.g., $5-$10 per visit). In various embodiments, the user device routine machine learning model may assign labels to the detected locations. For example, the user device routine machine learning model may determine that the location in the Charlotte suburbs is likely a residential address for the customer and the location in uptown Charlotte is likely a place of employment.

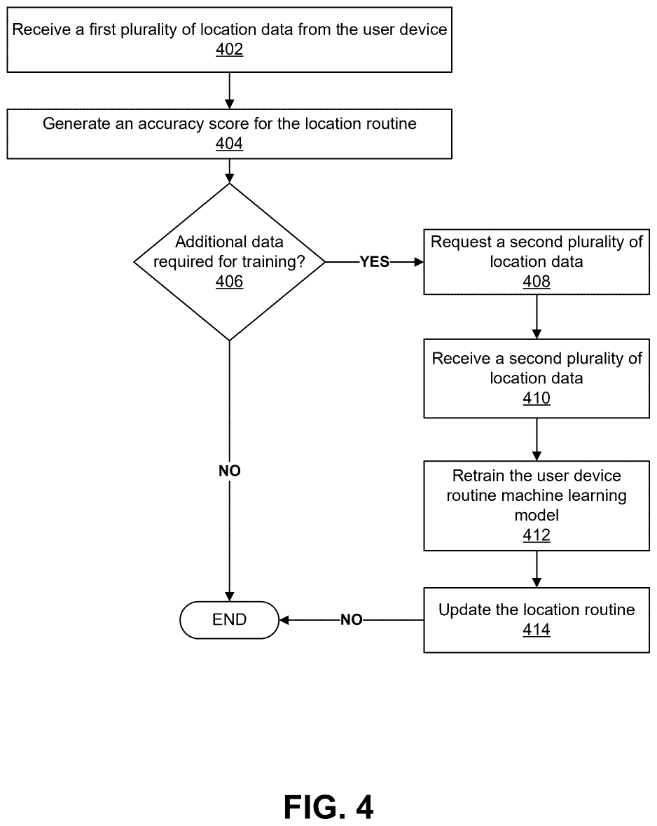

In various embodiments, the user device routine machine learning model may detect patterns of customer behavior over a week, a month, and/or a year, based on the volume of data (e.g., number of location data points) included in the first plurality of location data. For example, if the first plurality of location data ranges over a month, the user device routine machine learning model may be able to detect patterns of customer behavior over that period, such as grocery shopping on the first and third Saturday of the month. The user device routine machine learning model may be able to detect patterns in the account activity when the customer visits the grocery store. Thus, this recurring event information may be included in the location routine generated by the user device routine machine learning model. When the user device routine machine learning model has been trained on the first plurality of location data, the user device routine machine learning model may generate a location routine, which includes the detected pattern of customer behavior and account activity over the period of the first plurality of location data. In some embodiments, the user device routine machine learning model may be retrained using additional location data, as further described in FIG. 4.

As shown by operation 304, the apparatus 200 includes means, such as the communications hardware 206 or the like, for receiving a current location of the user device. The communications hardware 206 may receive the current location from a user device, such as the user device 106A. In some embodiments, the communications hardware 206 may receive location data from any one of the user devices 106A-106N. In some embodiments, the received current location may be location data collected by the user device 106A at a specific time and may reflect the most recent, up-to-date position of the user device 106A. The current location data may include GPS coordinates, an IP address, and/or other data that provides location information. The current location data may include the location of the user device 106A and a time stamp indicative of when the location data was captured by the user device 106A. In some embodiments, in order for location data to be current location data, its time stamp must fall within a predefined threshold relative to the present time (e.g., within 30 seconds). This ensures that the location data accurately reflects the user device's real-time or near real-time location and is therefore relevant for subsequent operations. For example, the current location data may be GPS coordinates and an associated time stamp of 2025-02-01T14:30:15Z. The time stamp may be formatted in ISO 8601 format, Unix epoch time, and/or any other suitable format. This may be indicative that the user device 106A is located at the GPS coordinates on Feb. 1, 2025, at 14:30:15 Coordinated Universal Time (UTC).

In some embodiments, the communications hardware 206 may receive the current location data from user device 106A if the customer enables location data to be shared. For example, as described in FIG. 8, a customer may access a settings interface on his/her user device (e.g., any one of the user devices 106A-106N) or within an associated mobile application associated with his/her customer account. Through this interface, the customer may toggle a location-sharing option, grant necessary permissions, and configure preferences such as the frequency of location updates. Once enabled, the communications hardware 206 may receive a plurality of location data from the user device (e.g., any one of the user devices 106A-106N). The communications hardware 206 may provide received location data to the location analysis engine 208. In some embodiments, the location analysis engine 208 may associate the location data with the customer account. In some embodiments, the location analysis engine 208 may associate the location data with the customer account by utilizing unique identifiers linked to the user device and/or customer account credentials. For example, location data may be received with an account identifier, user device identifier, authentication token, and/or the like. The location analysis engine 208 may verify these values against corresponding values stored in the customer account to determine and/or verify the location data is associated with a customer account.

As shown by operation 306, the apparatus 200 includes means, such as the location analysis engine 208 or the like, for determining whether a deviation condition for a candidate deviation event type is satisfied. In some embodiments, the location analysis engine 208 may receive the current location data of the user device 106A from the communications hardware 206. The location analysis engine 208 may then determine whether a deviation condition for a candidate deviation event type is satisfied. A candidate deviation event type may be a predefined category of potential deviations that the location analysis engine 208 may evaluate based on discrepancies between the current customer location and predicated locations defined in the location routine for the user device 106A. Each candidate deviation event type may represent a distinct class of deviation scenarios that may indicate anomalous user device location behavior, security risks, and/or operational inconsistencies.

In some embodiments, a candidate deviation event type may correspond to a residential relocation deviation event type, a workplace change deviation event type, an out-of-bounds travel deviation event type, a rapid location change deviation event type, a high-risk location deviation event type, a customer account behavior location deviation event type, and/or the like. Each candidate deviation event type may be associated with a deviation condition that defines the criteria for detecting and/or classifying a deviation event of the deviation event type. Additionally, each candidate deviation event type may be associated with defined operations to perform in response to the location analysis engine 208 detecting a deviation event corresponding to the deviation event type. The defined operations may allow the location analysis engine 208 to implement a structured response mechanism to mitigate security risks, enforce policy compliance, and enhance overall system reliability in a flexible manner, responsive to the particular deviation event type.

In some embodiments, the location analysis engine 208 may determine whether a deviation condition for a candidate deviation type is satisfied by analyzing a comparison between the current location of the user device 106A and a predicted location defined in the location routine or the user device 106A. In some embodiments, the location analysis engine 208 may determine the predicted location for the user device using the time stamp associated with the current location and the location routine. The location analysis engine 208 may determine which time window of the location routine that the time stamp corresponds to. In some embodiments, the location analysis engine 208 may convert the time stamp to a time zone of the location routine. For example, the time stamp may be 14:30:15 UTC. The location analysis engine 208 may convert the time stamp to 9:30:15 a.m. Eastern Standard Time (EST), which is the same moment but in EST instead of UTC, and this may allow the location analysis engine 208 to compare the time stamp to time windows of the location routine, which may also be represented in EST. By way of continuing example, the location analysis engine 208 may determine a time window of 9:00 a.m.-5:00 p.m. for the time stamp. The location analysis engine 208 may use the location routine to further determine a predicted location of location XYZ for the 9:00 a.m.-5:00 p.m. time window. Thus, the location analysis engine 208 may compare the current location to the predicted location XYZ when evaluating whether a deviation condition is satisfied.

In some embodiments, a deviation condition for a candidate deviation event type may define a frequency of discrepancies between the current location of the user device and the predicted locations within a defined time frame. A deviation condition may define a threshold number of discrepancies over a given time frame for a candidate deviation event type. For example, a deviation condition may define a threshold number of discrepancies of 14 over a two-week period. Thus, if the location analysis engine 208 determines that the location data of the user device has deviated from a predicted location 14 times (e.g., every day for the two-week period) for a 9:00 a.m.-5:00 p.m. time window, the location analysis engine 208 may determine the threshold number of discrepancies is satisfied. In some embodiments, the location analysis engine 208 may determine a discrepancy when it determines a mismatch between a current location of the user device 106A and a predicted location.

In some embodiments, the location analysis engine 208 may determine a discrepancy only when the mismatch persists for a minimum duration threshold. The minimum duration threshold may ensure that temporary location variations, such as GPS errors or minor detours, do not trigger superfluous deviation event detections. For example, a minimum duration threshold may be two hours. Thus, the location analysis engine 208 may determine that a discrepancy has occurred if the location data for the user device 106A has not matched or corresponded to a predicted location for over two hours. This may prevent the location analysis engine 208 from determining a discrepancy when a customer simply leaves the predicted location earlier or later than expected and/or temporarily leaves the predicted location (e.g., to perform errands, attend recreational activities, visit a restaurant, and/or the like).

In some embodiments, a deviation condition may define a deviation duration. A deviation duration may be a total length of time that the current location differs from predicted locations, even across different time windows. For example, a deviation duration may be 24 hours. Thus, the deviation condition may be satisfied in response to a mismatch between the location data from the user device 106A and a predicted location over a 24-hour period. This time period may include mismatches/discrepancies between a predicted location across multiple time windows (e.g., a 9:00 a.m.-5:00 p.m. time window, a 5:00p.m.-8:00 a.m. time window, and an 8:00 a.m.-9:00 a.m. time window).

In some embodiments, a deviation condition may define a location type associated with the current location of the user device 106A. In some embodiments, the deviation condition may require that a current location corresponds to a location type and/or does not correspond to a location type. For example, a deviation condition may define that a location type for a current location needs to correspond to a residential location, a business location, a public area, or another type of classified environment. In some embodiments, the location analysis engine 208 may determine a location type by cross-referencing the current location against a database of known addresses. The database of known addresses may further indicate whether the location is a residential, commercial, or public address.

In some embodiments, a deviation condition may define a maximum distance between a current location of the user device 106A and a previous location of the user device 106A. In some embodiments, a maximum distance may define a maximum travel speed. For example, the maximum travel speed may be 600 miles per hour, which may correspond to top speeds of commercial aircrafts. If the distance between the current location of the user device 106A and a previously recorded location of the user device 106A over a delta time is analyzed as greater than the maximum distance for that delta time, as determined based on the maximum travel speed, the deviation condition may be satisfied.

In some embodiments, a deviation condition may define a geographic threat assessment requirement for a current location. In some embodiments, a geographic threat assessment condition may refer to one or more security requirements, restrictions, or classifications for a current location. For example, certain locations may be flagged as blacklisted, restricted, or otherwise high-risk zones. These flags may be temporary in response to an emerging or suspected local threat or they may be permanent. In some embodiments, the memory 204 may store a list of locations (e.g., location name, GPS coordinates, IP addresses, or the like) along with one or more flags indicative of any security restrictions or classifications for the location. In some embodiments, the communications hardware 206 may be configured to query one or more security databases and/or receive alerts or notifications, such as from law enforcement devices, and may update the list of locations accordingly. A geographic threat assessment requirement may require that a current location be associated with no flags or only certain flags. If a current location is associated with a flag that is prohibited by a geographic threat assessment requirement, the deviation condition may be satisfied.

In some embodiments, a deviation condition may define one or more transaction thresholds for customer account activity at a current location that corresponds to a predicted location. In some embodiments, the location routine may include a historical customer account activity transaction average, historical customer account activity transaction range, and/or the like for historical transactions that occur at a predicted location. For example, a deviation condition may include a transaction threshold of no more than 20% above the historical customer account activity transaction average. As another example, a deviation condition may include a transaction threshold of no more than $200 above the upper bounds of the historical customer account activity transaction range.

In some embodiments, a deviation condition for a residential relocation deviation event type may define a frequency of discrepancies and a location type. For example, the deviation condition for a residential relocation deviation event type may define a threshold number of discrepancies of 14 over a two-week period. Additionally, the deviation condition for the residential relocation deviation event type may define that a current location corresponds to a residential location type. The location analysis engine 208 may then determine whether the deviation condition for a residential relocation deviation event type has been satisfied based on whether the current location is a discrepancy that exceeds a threshold number of discrepancies and the current location corresponds to a residential location type. For example, the location analysis engine 208 may determine a deviation condition for a residential relocation deviation event type has been satisfied in response to determining that the current location is the 14th discrepancy within a two-week period and the current location corresponds to a residential address.

In some embodiments, a deviation condition for a workplace change deviation event type may define a frequency of discrepancies and a location type. For example, the deviation condition for a workplace change deviation event type may define a threshold number of discrepancies of 14 over a two-week period. Additionally, the deviation condition for the workplace change deviation event type may define that a current location corresponds to a commercial location type. The location analysis engine 208 may then determine whether the deviation condition for a workplace change deviation event type has been satisfied based on whether the current location is a discrepancy that exceeds a threshold number of discrepancies and the current location corresponds to a commercial location type. For example, the location analysis engine 208 may determine a deviation condition for a workplace change deviation event type has been satisfied in response to determining that the current location is the 14th discrepancy within a two-week period and the current location corresponds to a commercial address.

In some embodiments, a deviation condition for an out-of-bounds travel deviation event type may define a deviation duration. For example, the deviation duration may be 24 hours. The location analysis engine 208 may determine whether the deviation condition for an out-of-bounds travel deviation event type has been satisfied based on whether the current location is a discrepancy that exceeds a deviation duration. For example, the location analysis engine 208 may determine a deviation condition for an out-of-bounds travel deviation event type has been satisfied in response to determining that the current location is a discrepancy that has exceeded 24 hours (e.g., the user device 106A has not been located at a predicted location for over 24 hours).

In some embodiments, a deviation condition for a rapid location change deviation event type may define a maximum distance between the current location and a previous location. For example, a maximum travel speed may be defined as 600 miles within 60 minutes. The location analysis engine 208 may determine a delta time based on the time stamp associated with the current location of the user device 106A and a time stamp associated with the previous location associated with user device 106A. The location analysis engine 208 may determine the maximum distance based on the maximum travel speed and the delta time. For example, the location analysis engine 208 may determine a maximum distance of 1,200 miles for the delta time of 120 minutes. The location analysis engine 208 may determine a distance between the current location and the previous location. The location analysis engine 208 may determine a deviation condition for a rapid location change deviation event is satisfied if the distance exceeds the maximum distance. By way of continuing example, the location analysis engine 208 may determine a deviation condition for a rapid location change deviation event type is satisfied if the distance between the current location and a previous location is greater than 1,200 miles for the delta time of 120 minutes.

In some embodiments, a deviation condition for a high-risk location deviation event type may define a geographic threat assessment requirement for a current location. In some embodiments, the location analysis engine 208 may determine whether the current location is flagged as a restricted, blacklisted, or otherwise a high-risk zone. In some embodiments, the location analysis engine 208 may access the list of locations from an associated memory, such as the memory 204, and determine whether the current location is associated with a flag. For example, the location analysis engine 208 may query the list for GPS coordinates, an IP address, and/or the like of the current location. The location analysis engine 208 may determine a deviation condition for a high-risk location deviation event type is satisfied in response to determining the current location is associated with a flag.

In some embodiments, a deviation condition for a customer account activity deviation event type may define boundaries of acceptable or expected customer account activity for a current location. In some embodiments, the location routine may include a historical customer account activity transaction average, historical customer account activity transaction range, and/or the like for historical transactions that occur at a predicted location. A deviation condition for a customer account activity deviation event type may define one or more thresholds based on the transaction average and/or transaction range. For example, a deviation condition may include a transaction threshold of no more than 20% above the historical customer account activity transaction average. Thus, if a transaction at a current location corresponding to a predicted location exceeds the historical customer account activity transaction average for the predicted location by more than 20%, the location analysis engine 208 may determine a deviation condition for a customer account activity deviation event type is satisfied. As another example, a deviation condition may include a transaction threshold of no more than $200 above the upper bounds of the historical customer account activity transaction range. Thus, if a transaction at a current location corresponding to a predicted location exceeds the upper bound of a historical customer account activity transaction range for the predicted location by more than $200, the location analysis engine 208 may determine a deviation condition for a customer account activity deviation event type is satisfied.

As shown by operation 308, the apparatus 200 includes means, such as the location analysis engine 208 or the like, for detecting an occurrence of a deviation event associated with a deviation event type in response to determining that the deviation condition for a candidate deviation event is satisfied. As described above, the location analysis engine 208 may determine whether a deviation condition for a candidate deviation event type is satisfied. Upon determining a deviation for one or more candidate deviation event types are satisfied, the location analysis engine 208 may detect an occurrence of a deviation event in response. The location analysis engine 208 may associate the deviation event with the corresponding deviation event types. For example, if the location analysis engine 208 determines that a deviation condition for an out-of-bounds travel deviation event type and a deviation condition for a high-risk location deviation event type were satisfied, the location analysis engine 208 may detect an occurrence of a deviation event and associate the deviation event with an out-of-bounds travel deviation event type and a high-risk location deviation event type.

It will be appreciated that the location analysis engine 208 may evaluate whether a deviation condition is satisfied for multiple candidate deviation event types simultaneously, such as by leveraging parallel processing operations. In this way, example embodiments may detect a deviation event in real time, thereby minimizing response delays.

As shown by operation 310, the apparatus 200 includes means, such as the communications hardware 206, the location analysis engine 208, or the like, for updating a customer account associated with the user device. In some embodiments, the location analysis engine 208 may update the customer account. The location analysis engine 208 may update a customer account based on the customer deviation event type(s) associated with the deviation event. As described above, a customer deviation event type may be associated with defined operations to perform in response to detecting a deviation event corresponding to the deviation event type. In some embodiments, these defined operations may be stored in a memory, such as the memory 204. The location analysis engine 208 may access the memory to determine the defined operations for the associated deviation event types and may update the customer account based on these operations. The defined operations may allow the location analysis engine 208 to implement a structured response mechanism to mitigate security risks, enforce policy compliance, and enhance overall system reliability in a flexible manner, responsive to the particular deviation event type.

In some embodiments, the location analysis engine 208 may update a customer account by applying an account restriction. The account restriction may be a dynamically applied restriction on the customer account that applies until it is removed by the location analysis engine 208. In some embodiments, the account restriction may apply a temporary spending limit (e.g., a maximum allowable total for all financial transactions), prevent customer account activity (e.g., blocking the customer account), terminate all current active digital sessions associated with the customer account, require additional authentication before allowing a customer to access the customer account, disallow certain payment methods (e.g., wire transfers), impose limits on outgoing transfers (e.g., ATM withdrawals, peer-to-peer transactions), and/or the like. In some embodiments, the location analysis engine 208 may remove the account restriction once the customer successfully verifies his/her identity.

In some embodiments, the location analysis engine 208 may update a customer account by modifying customer information within the customer account. In some embodiments, the location analysis engine 208 may determine that certain customer information within the customer account is outdated or no longer accurate based on the detection of the deviation event. For example, the location analysis engine 208 may determine the residential address, work address, and/or employer customer information is no longer accurate. The location analysis engine 208 may automatically update this customer information based on the current location and/or input from the customer received by the communications hardware 206 from user device 106A.

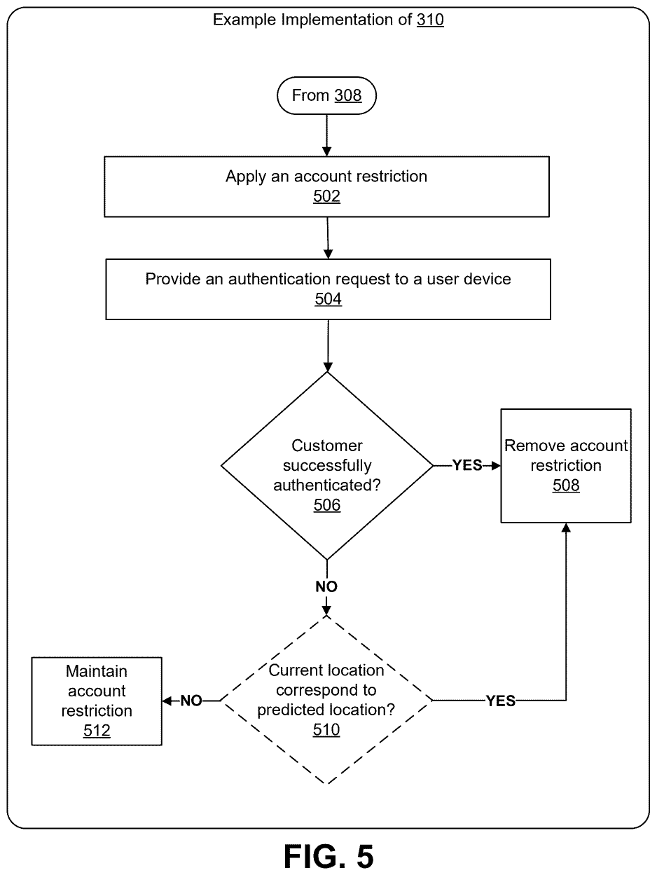

The particular updates to a customer account for each deviation event type are described in further detail with respect to FIGS. 5-7 below.

FIGS. 5-7 illustrate how the apparatus 200 may update a customer account based on the deviation event type. Once the location analysis engine 208 has determined a deviation event type and detected a deviation event as described in operations 306-308 of FIG. 3, the apparatus 200 may update the customer account and, in some embodiments, perform one or more additional actions based on the deviation event type. The actions performed may be dependent upon the type of deviation event. Thus, the actions may update a customer account in an efficient and tailored manner to address the specific deviation type.

Turning first to FIG. 5, example operations are shown that illustrate performance of an example of updating a customer account for an out-of-bounds travel deviation event type, a rapid location change deviation event type, a high-risk location deviation event type, and/or a customer account activity deviation event type. As described in FIG. 5, the location analysis engine 208 may apply access restrictions on the customer account for the safety of the customer's account. Placing these temporary restrictions may help mitigate potential threats to the customer account, such as unauthorized account access, identity theft, physical security risks, and/or financial fraud. Advantageously, by automatically placing these temporary restrictions on the customer account, example embodiments may proactively prevent these adverse outcomes from occurring in the first place.

As shown by operation 502, the apparatus 200 includes means, such as the location analysis engine 208 or the like, for applying an account restriction to the customer account. As described in operation 310, an account restriction may be a dynamically applied restriction on the customer account that applies until it is removed by the location analysis engine 208. In some embodiments, the account restriction may apply a temporary spending limit (e.g., a maximum allowable total for all financial transactions), prevent customer account activity (e.g., blocking the customer account), terminate all current active digital sessions associated with the customer account, require additional authentication before allowing a customer to access the customer account, disallow certain payment methods (e.g., wire transfers), impose limits on outgoing transfers (e.g., ATM withdrawals, peer-to-peer transactions), and/or the like. This account restriction may remain in the customer account until the customer is successfully authenticated. In some embodiments, the account restriction may be automatically removed once the current location of the user device 106A is in a predicted location.

In some embodiments, the defined operations for each of an out-of-bounds travel deviation event type, a rapid location change deviation event type, a high-risk location deviation event type, and/or customer account activity deviation event type may include applying one or more account restrictions to the customer account. In some embodiments, the particular values for the restrictions (e.g., various limits) may also be defined for the deviation event type. Thus, the location analysis engine 208 may identify the defined account restrictions for the corresponding deviation event type and may apply these account restrictions to the customer account.

In some embodiments, the location analysis engine 208 may further temporarily place a hold on physical correspondence (e.g., flyers, replacement bank cards, financial statements, and/or the like) in response to detecting the occurrence of the deviation event. For example, in some embodiments, the location analysis engine 208 may place a temporary hold on sending out physical correspondence if the deviation event type is an out-of-bounds travel deviation event type, as this may indicate that the customer is traveling. Thus, the location analysis engine 208 may prevent sensitive information from being sent to the customer's residence when he/she is not home, thereby reducing the risk of potential exposure of sensitive customer information. The location analysis engine 208 may lift the temporary hold once the current location corresponds to a predicted location, which may be indicative that the customer is home.

As shown by operation 504, the apparatus 200 includes means, such as the communications hardware 206 or the like, for providing an authentication request to a user device. The authentication request may prompt the customer to confirm customer identity. In some embodiments, the authentication request may request the customer to provide one or more customer credentials. In some embodiments, the communications hardware 206 may send an authentication request to the user device 106A. The authentication request may take the form of a request for the customer to confirm customer identity through the entities' associated mobile application and/or using biometric identification techniques (e.g., fingerprint reader, facial recognition, iris scanning) of the user device 106A. In some embodiments, the authentication request may request customer credentials, such as a password and/or a passkey associated with the customer account.

As shown by operation 506, the apparatus 200 includes means, such as the communications hardware 206, the location analysis engine 208, or the like, for receiving an authentication response from the user device. The authentication response may include input candidate customer credentials provided by the customer. The location analysis engine 208 may then compare the provided candidate customer credentials to the stored customer credentials. If the provided candidate customer credentials sufficiently correspond to the stored customer credentials (e.g., passwords exactly match, a similarity score for biometric data satisfies a similarity score threshold, a digital signature for a passkey is determined to match a digital signature for the user device, and/or the like), the location analysis engine 208 may successfully authenticate the customer. If the customer was successfully authenticated, the process may continue at operation 508. If the customer failed to be successfully authenticated, the process may continue at operation 510 or may proceed directly to operation 512.

As shown by operation 508, the apparatus 200 includes means, such as the communications hardware 206, the location analysis engine 208, or the like, for removing the account restriction from the customer account. If the location analysis engine 208 determines the customer was successfully authenticated based on the authentication response, the location analysis engine 208 may remove the account restriction. If the customer is successfully authenticated, this may serve to confirm the identity of the customer and ensure the user device is currently with the customer. Thus, even if the user device deviates from the location routine, the customer may override customer account restrictions. This may be particularly advantageous when the user device deviations are legitimate deviations, such as when the customer is traveling.

Optionally, as shown by operation 510, the apparatus 200 may include means, such as the communications hardware 206, the location analysis engine 208, or the like, for determining whether the current location of the user device corresponds to a predicted location. If the location analysis engine 208 determines the customer failed to be authenticated based on the authentication response, the location analysis engine 208 may request an updated customer location from the user device 106A. The communications hardware 206 may receive a new current location from the user device 106A in response to the request. The location analysis engine 208 may use the location routine to determine if the new current location corresponds to (e.g., is located in or within) the predicted location. In some embodiments, if the location analysis engine 208 corresponds to the predicted location, the location analysis engine 208 may proceed to operation 508. If the location analysis engine 208 fails to correspond to the predicted location, the location analysis engine 208 may proceed to operation 512.

As shown by operation 512, the apparatus 200 may include means, such as the location analysis engine 208 or the like, for maintaining the account restriction. In some embodiments, if the location analysis engine 208 does not receive an authentication response that successfully authenticates the customer, the location analysis engine 208 may maintain the account restriction in the customer account. In some embodiments, if the location analysis engine 208 does not receive an authentication response that successfully authenticates the customer and determines a new current location fails to correspond to a predicted location, the location analysis engine 208 may maintain the account restriction in the customer account. This helps protect the customer account from unauthorized access. In some embodiments, the customer may remove the temporary account limitations by providing an authentication response to an authentication request and/or by successfully logging into the customer account via a mobile application on the user device 106A.

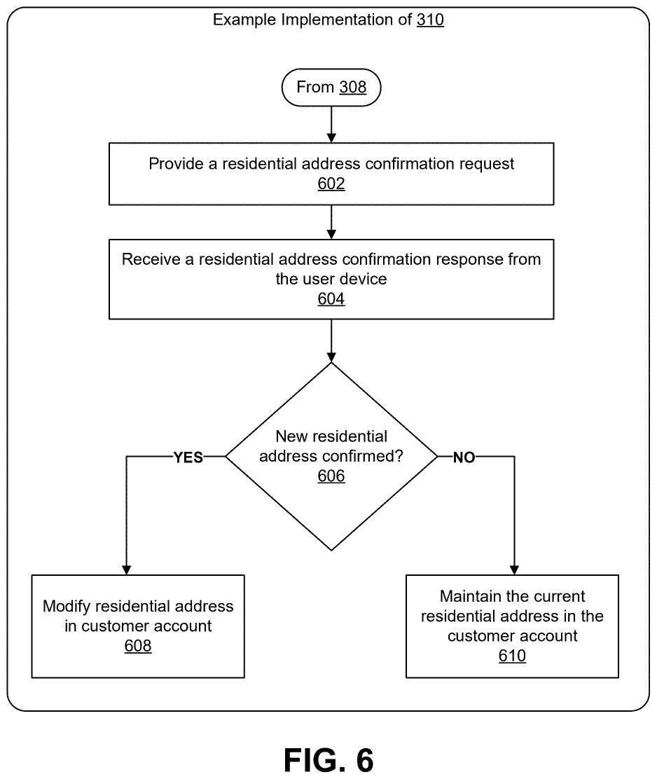

Turning next to FIG. 6, example operations are shown for updating a customer account for a residential relocation deviation event type. As described in FIG. 6, the location analysis engine 208 may modify customer information within a customer account for a residential relocation deviation event type. Advantageously, by automatically detecting and updating a residential address change, example embodiments may ensure the customer information is up to date and accurate, thereby reducing security risk associated with outdated information, such as mailing sensitive information to an incorrect address.

As shown by operation 602, the apparatus 200 may include means, such as the communications hardware 206 or the like, for providing a residential address confirmation request to a user device. In some embodiments, the communications hardware 206 may provide a residential address confirmation request to the user device 106A if the detected deviation event is associated with a residential relocation deviation event type. In some embodiments, the residential address confirmation request may include a request for the customer to confirm and/or update his/her residential address information. In some embodiments, the residential address confirmation request may include the address associated with the current location as determined by the location analysis engine 208. The residential address confirmation request may prompt the customer to confirm whether this is his/her new residential address. In some embodiments, the residential address confirmation request may include the customer address currently used as the residential address and ask the customer to confirm if this address is still valid. The residential address confirmation request may allow the customer to modify the included address and/or input a new address.

In some embodiments, the location analysis engine 208 may automatically update the customer's residential address to the current location address. The location analysis engine 208 may flag the updated residential address as unverified. The updated residential address may be verified in response to the customer confirming the updated residential address.

As shown by operation 604, the apparatus 200 may include means, such as the communications hardware 206 or the like, for receiving a residential address confirmation from the user device 106A. In some embodiments, the communications hardware 206 may receive the residential address confirmation from user device 106A. In some embodiments, the residential address confirmation may confirm that the address associated with the current location is the customer's new residential address (e.g., a binary response of yes or no). In some embodiments, the residential address confirmation may include a new address as provided by the customer. Advantageously, this may help supplement any gaps missing from the current location data, such as apartment numbers. The residential address confirmation may include whether the customer wishes to update his/her residential address or to maintain his/her current address information.

As shown by operation 606, the apparatus 200 may include means, such as the location analysis engine 208 or the like, for determining whether the customer confirms a new residential address. If the residential address confirmation includes confirmation of a new residential address (e.g., confirms the current location is the new address or includes a new address input by the customer), the process continues at operation 608. If the residential address confirmation fails to confirm a new residential address and/or denies the new residential address, the process continues at operation 610.

As shown by operation 608, the apparatus 200 may include means, such as the location analysis engine 208 or the like, for modifying the residential address in the customer account. The location analysis engine 208 may modify the residential address based on the residential address included in the residential address confirmation response. For example, if the residential address confirmation response confirmed that the address associated with the current location is the customer's new residential address, the location analysis engine 208 may update the customer information to reflect the address associated with the current location as the customer's residential address. As another example, if the residential address confirmation response includes a new residential address input by the customer, the location analysis engine 208 may update the customer information to reflect the address input by the customer as the customer's residential address.

In some embodiments, if the location analysis engine 208 has already updated the customer account to reflect the current location as the new residential address, the location analysis engine 208 may verify the new residential address if the residential confirmation response confirms the new residential address. Otherwise, the location analysis engine 208 may update the customer account to reflect the confirmed residential address and may associate the residential address with a verification flag or indicator. The verification flag or indicator may be associated with the date and/or time the customer confirmed the accuracy of the residential address.

In some embodiments, in response to modifying the residential address, the location analysis engine 208 may request additional location data from the user device 106A. This additional location data may be used to train a user device routine machine learning model, as described in FIG. 4, to produce an updated and more accurate location routine based on the new residential address. The updated location routine may be considerate of potential changes in the user device's location that may occur due to a change in residential address. For example, with a change in residential address, the user device 106A may frequent a different location for grocery shopping, a different café on the way to work, etc. The location analysis engine 208 may update the location routine based on these changes contained within the additional location data that may be provided.

As shown by operation 610, the apparatus 200 may include means, such as the location analysis engine 208 or the like, for maintaining the current residential address in the customer account. In some embodiments, the residential address confirmation may fail to provide confirmation of the current residential address as a new residential address and/or may deny the new residential address. In response, the location analysis engine 208 may maintain the current residential address in the customer account.

In some embodiments, if the location analysis engine 208 has already updated the customer account to reflect the current location as the new residential address, the location analysis engine 208 may revert the residential address to the previous address. In some embodiments, the residential address may be associated with an unverified flag or indicator until the customer confirms the accuracy of the residential address.

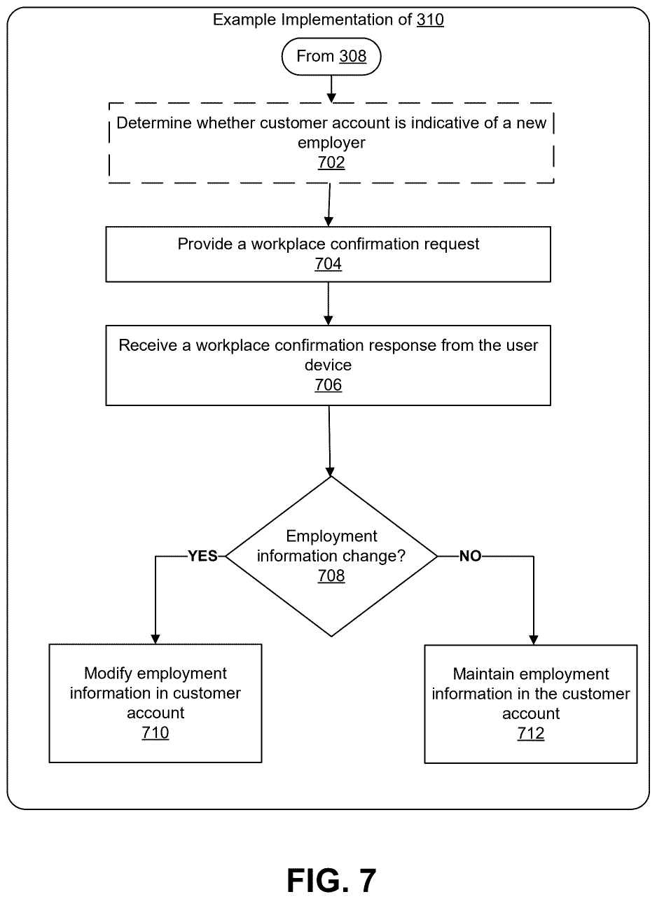

Turning next to FIG. 7, example operations are shown for updating a customer account for a workplace change deviation event type. As described in FIG. 7, the location analysis engine 208 may modify customer information within a customer account for a workplace change deviation event type. Advantageously, by automatically detecting and updating a workplace address change and/or employer change, example embodiments may provide response services and resources to the customer based on potential changes of employment. For example, if the customer has changed jobs and now has an increased salary, the customer may be offered a new line of credit based on his/her new income. Additionally, confirming the customer's employment information may also provide additional customer account security and/or may allow the employment information to be used to verify a customer's source of income for various compliance and/or regulatory purposes.

Optionally, as shown by operation 702, the apparatus 200 may include means, such as the communications hardware 206, the location analysis engine 208, or the like, for determining whether the customer account is indicative of a new employer. In various embodiments, the location analysis engine 208 may access the customer account repository 110 to extract customer account information that may be indicative of the customer having a new workplace. For example, the customer may have a new direct deposit from the business that is associated with the first location. In some embodiments, the location analysis engine 208 may identify a most recent direct deposit within the customer account. In some embodiments, direct deposits may be stored within an associated storage location (e.g., customer account repository 110) and the location analysis engine 208 may use the communications hardware 206 to access the direct deposit data within the storage location.

In some embodiments, the location analysis engine 208 may determine whether a payor associated with the most recent direct deposit corresponds to a payor associated with one or more historical direct deposits. In various embodiments, the location analysis engine 208 may compare the most recent direct deposit in a customer's account with historical direct deposits to determine whether the information matches. The location analysis engine 208 may compare a payor, payor account number, and/or amount paid between direct deposits. For example, the location analysis engine 208 may determine that a most recent direct deposit lists a payor as Green Company and a second most recent direct deposit (e.g., a historical direct deposit) lists a payor as Purple Company. The location analysis engine 208 may determine that the payor information for the most recent direct deposit does not match the payor information for the historical direct deposit. Thus, the location analysis engine 208 may determine the customer information is indicative of a new workplace.

In some embodiments, in response to determining that the customer information is indicative of a new workplace, the location analysis engine 208 may automatically update the customer's workplace address to the current location address and/or the employer to the employer associated with the address and/or most recent direct deposit. The location analysis engine 208 may flag the updated employer address and/or employer as unverified. The updated workplace address and/or employer may be verified in response to the customer confirming the updated values in the workplace confirmation response.

As shown by operation 704, the apparatus 200 may include means, such as the communications hardware 206, the location analysis engine 208, or the like, for providing a workplace confirmation request to a user device. In some embodiments, the communications hardware 206 may provide a workplace confirmation request to the user device 106A if the detected deviation event is associated with a workplace change deviation event type. In some embodiments, the workplace confirmation request may include a request for the customer to confirm and/or update his/her employment information. Employment information may include the name of an employer, a workplace address, a workplace phone number, salary information, a job title, and/or the like. In some embodiments, the workplace request may include the address associated with the current location as determined by the location analysis engine 208. In some embodiments, the workplace request may include an employer name that corresponds to a business name registered at the address of the current location. The location analysis engine 208 may determine the business name using the communications hardware 206 to query online databases and/or repositories. The workplace confirmation request may prompt the customer to confirm whether the address of the current location is his/her new workplace address, the business name is his/her new employer's name, and whether other existing employment information (e.g., a workplace phone number, salary information, a job title) within the customer account is correct. The workplace confirmation request may allow the customer to modify the included values and/or input new values. The location analysis engine 208 may cause the communications hardware 206 to provide the workplace confirmation request to the user device 106A.

In some embodiments, the location analysis engine 208 may automatically update the customer's workplace address to the current location address and/or the employer to the employer associated with the address. The location analysis engine 208 may flag the updated employer address and/or employer as unverified. The updated workplace address and/or employer may be verified in response to the customer confirming the updated values in the workplace confirmation response.

As shown by operation 706, the apparatus 200 may include means, such as the communications hardware 206 or the like, for receiving a workplace confirmation response from the user device. In some embodiments, the communications hardware 206 may receive the workplace confirmation response from user device 106A. In some embodiments, the workplace confirmation response may confirm whether a provided value for employment information is correct. For example, the workplace confirmation response may provide an indication of whether the provided address associated with the current location is the customer's workplace address, whether a business associated with the address is the customer's employer, whether a workplace phone number is correct, whether current salary information is correct, whether a current job title is correct, and/or the like (e.g., a binary response of yes or no). In some embodiments, the residential workplace confirmation may include values input by the customer.

As shown by operation 708, the apparatus 200 may include means, such as the location analysis engine 208 or the like, for determining whether the customer confirms a change in employment information. In some embodiments, a workplace address confirmation may confirm that the business is the customer's new employer (e.g., a binary response of yes or no). In some embodiments, the workplace address confirmation may include an updated workplace address, employer, workplace phone number, salary information, and/or job title as provided by the customer. If the workplace address confirmation includes confirmation of any updated employment information (e.g., a change in workplace address, employer, workplace phone number, salary information, and/or job title), the process continues at operation 710. If the workplace address confirmation fails to confirm or denies any changes in employment information, the process continues at operation 712.

As shown by operation 710, the apparatus 200 may include means, such as the communications hardware 26, the location analysis engine 208, or the like, for modifying employment information within the customer account. The location analysis engine 208 may modify the employment information within the customer account based the workplace confirmation response. For example, if the workplace confirmation response confirmed that the address associated with current location is the customer's new workplace address, the location analysis engine 208 may update the customer information to reflect the address associated with the current location as the customer's workplace address. The location analysis engine 208 may determine whether values provided by the customer via the workplace confirmation response match values within the customer account for corresponding data fields. If not, the location analysis engine 208 may update the customer information to reflect the values included in the workplace confirmation response. For example, the location analysis engine 208 may modify the customer account to replace existing values for a workplace address, employer, workplace phone number, salary information, and/or job title with the workplace address, employer, workplace phone number, salary information, and/or job title included in the workplace confirmation response.

In some embodiments, if the location analysis engine 208 has already updated the customer account to reflect the current location as the workplace address and/or employer, the location analysis engine 208 may verify the new workplace address and/or employer if the workplace confirmation response confirms it as the new workplace address and/or employer. Otherwise, the location analysis engine 208 may update the customer account to replace the workplace address and/or employer with the workplace address and/or employer indicated by the workplace confirmation response and may associate these values with a verification flag or indicator. The verification flag or indicator may be associated with the date and/or time the customer confirmed the accuracy of the workplace address and/or employer.

In some embodiments, the location analysis engine 208 may determine whether the modification to the employment information within the customer account has made the customer eligible for one or more programs he/she was previously ineligible for. For example, the location analysis engine 208 may determine that the modified salary included in the customer's account qualifies the customer for an increased credit limit. As another example, the location analysis engine 208 may determine that the customer's new employer is enrolled in benefit programs associated with the apparatus 200, and thus, the customer is now eligible for these programs. In some embodiments, the location analysis engine 208 may use the communications hardware 206 to provide an eligibility notification to the user device 106A. The eligibility notification may inform the customer of his/her eligibility in any identified programs. Advantageously, this informs the customer of his/her eligibility in a timely manner.

In some embodiments, the location analysis engine 208 may determine that the employment information is used as a security question for the customer account. In some embodiments, the location analysis engine 208 may automatically update the answer to the security question based on the updated information in the customer account. The location analysis engine 208 may use the communications hardware 206 to provide a notification to the user device 106A. The notification may inform the customer that a security question response has been updated in his/her account based on the workplace confirmation response. Thus, the customer may be made aware of this security change.

As shown by operation 712, the apparatus 200 may include means, such as the location analysis engine 208 or the like, for maintaining the current employment information in the customer account. In some embodiments, the workplace confirmation may fail to provide confirmation of the employment information and/or may deny any change in workplace information. In response, the location analysis engine 208 may maintain the current employment information associated with the customer account.

In some embodiments, if the location analysis engine 208 has already updated the customer account to reflect the current location as the new workplace address and/or a business located at the address as the employer, the location analysis engine 208 may revert the workplace address and/or employer to their previous values. In some embodiments, these values may be associated with an unverified flag or indicator until the customer confirms the accuracy of the workplace address and/or employer.

Turning now to FIG. 4, example operations are shown for determining when to update a user device routine machine learning model. In particular, example embodiments may determine whether the location routine, generated by the user device routine machine learning model, accurately reflects the user device's location patterns. If the accuracy score of the location routine falls below an accuracy score threshold, the user device routine machine learning model may be retrained using additional location data received from the user device 106A, and the location routine may be updated.

As shown by operation 402, the apparatus 200 includes means, such as the communications hardware 206, the location analysis engine 208, or the like, for receiving a first plurality of location data. In some embodiments, the communications hardware 206 may receive location data from the user device 106A at periodic intervals or in response to a trigger event (e.g., the customer logging into a customer account via the user device 106A). The location data may include GPS coordinates, an IP address, and/or other data that provides location information. The location data may further be associated with a time stamp indicative of the time and/or date the when the location data was captured. In some embodiments, the location analysis engine 208 may store and/or maintain received location data in an associated memory, such as the memory 204.

The location analysis engine 208 may include the stored plurality of location data in a first plurality of location data. Thus, the first plurality of location data may include one or more location data points received from the user device 106A. The location analysis engine 208 may determine whether the first plurality of location data includes a requisite number of location data points. If so, the procedure may proceed to operation 404. If not, the communications hardware 206 may continue to receive location data from the user device 106A, and the location analysis engine 208 may include this location data as a location data point in the first plurality of location data until the requisite number of location data points is satisfied. Thus, the location analysis engine 208 may ensure the first plurality of location data includes a sufficient number of location data points.

As shown by operation 404, the apparatus 200 includes means, such as the location analysis engine 208 or the like, for generating an accuracy score for the location routine. An accuracy score may be a representation of the predictive accuracy of the location routine for the real location data points included in the second plurality of location data. In some embodiments, the location analysis engine 208 may use a variety of statistical methods for determining the predictive accuracy of the location routine. For example, the location analysis engine 208 may determine a number of discrepancies for the location data points within the first plurality of location data as compared to the predicted locations defined in the location routine. The location analysis engine 208 may detect discrepancies in a substantially similar manner as described in operation 306. The location analysis engine 208 may then determine an accuracy score based on statistical analysis methods. In some embodiments, the location analysis engine 208 may generate the accuracy score using a mean absolute error, root mean square error, and/or the like.

As shown by operation 406, the apparatus 200 includes means, such as the location analysis engine 208 or the like, for determining whether the accuracy score for the location routine satisfies an accuracy score threshold. In some embodiments, the location analysis engine 208 may include an accuracy score threshold that the accuracy score must satisfy in order for the location routine to continue to be used. If the accuracy score fails to satisfy the accuracy score threshold, the location analysis engine 208 may determine that the location routine should be updated and may proceed to operation 408. If the accuracy score satisfies the accuracy score threshold, the location analysis engine 208 may determine that the generated location routine is accurate and may continue to be used.

As shown by operation 408, the apparatus 200 includes means, such as the location analysis engine 208 or the like, for requesting a second plurality of location data relating to the customer account from a user device (e.g., any one of the user devices 106A-108N). In some embodiments, the location analysis engine 208 may use the communications hardware 206 to provide a request for additional location data to the user device 106A. In some embodiments, this request for a second plurality of location data may include a request to temporarily increase the frequency of the user device 106A providing location data to the communications hardware 206. This may allow the location analysis engine 208 to retrain the user device routine machine learning model to produce an updated location routine more quickly. The increased location data frequency provision may be temporary until the location routine is updated.

This additional location data may be used to retrain the user device routine machine learning model and thus update the location routine. In some embodiments, the location analysis engine 208 may determine the volume of additional location data required to further train the user device routine machine learning model based on the degree of deviation the accuracy score is from the accuracy score threshold. For example, if the accuracy score falls below a predefined value or percentage of the accuracy score threshold, the location analysis engine 208 may request two months of location data to be included in the second plurality of location data. In another example, if the accuracy score fails to satisfy the accuracy score threshold but is above a predefined value or percentage, the location analysis engine 208 may request two weeks of location data to be included in the second plurality of location data.

As shown by operation 410, the apparatus 200 includes means, such as the communications hardware 206 or the like, for receiving the second plurality of location data. In some embodiments, the communications hardware 206 may receive the location data from a user device (e.g., any one of the user devices 106A-106N). In some embodiments, the communications hardware 206 may receive location data from the user device 106A at periodic intervals or in response to a trigger event (e.g., the customer logging into a customer account via the user device 106A). The location data may include GPS coordinates, an IP address, and/or other data that provides location information. The location data may further be associated with a time stamp indicative of the time and/or date the when the location data was captured. This time period may overlap with the time period during which the first plurality of customer location data was collected or may be a different time period. In some embodiments, the location analysis engine 208 may store and/or maintain received location data in an associated memory, such as the memory 204.

The location analysis engine 208 may include the stored plurality of location data in a second plurality of location data. Thus, the second plurality of location data may include one or more location data points received from the user device 106A. In some embodiments, the second plurality of location data may refer to location data points collected over a defined time period. In some embodiments, the second plurality of location data may include all location data points collected over a time frame, such as over one day, one week, one month, etc. The location analysis engine 208 may determine whether the first plurality of location data includes a requisite number of location data points. If so, the procedure may proceed to operation 412. If not, the communications hardware 206 may continue to receive location data from the user device 106A, and the location analysis engine 208 may include this location data as a location data points in the second plurality of location data until the requisite number of location data points is satisfied. Thus, the location analysis engine 208 may ensure the second plurality of location data includes a sufficient number of location data points.

As shown by operation 412, the apparatus 200 includes means, such as the location analysis engine 208, the training engine 210, or the like, for training a user device routine machine learning model. In some embodiments, the training engine 210 may generate a training dataset for the user device routine machine learning model. The training engine 210 may generate the training dataset based on the second plurality of location data. In some embodiments, the training dataset includes the second plurality of location data. The training dataset may be provided to the user device routine machine learning model. The training engine 210 may retrain the user device routine machine learning model using the training dataset. This allows for the user device routine machine learning model to increase the predictive accuracy of the location routine. The user device routine machine learning model may then output an updated location routine to the location analysis engine 208, and the location analysis engine 208 may update and/or replace the previous location routine with the updated location routine. In some embodiments, the location analysis engine 208 may determine the accuracy of the updated location routine by generating a new accuracy score in a similar manner as described in operation 404, and the process may be repeated. The second plurality of location data may be used for generating the accuracy score for the updated location routine.

As shown by operation 414, the apparatus 200 includes means, such as the location analysis engine 208 or the like, for updating the location routine. As described above, the training engine 210 may retrain the user device routine machine learning model using the second plurality of location data. In turn, the user device routine machine learning model may output an updated location routine for the user device 106A. The location analysis engine 208 may update and/or replace the previous location routine with the updated location routine. For example, the location analysis engine 208 may use the communications hardware 206 to replace the location routine in an associated memory, such as the memory 204, or in an associated repository, such as the customer account repository 110. In some embodiments, the location analysis engine 208 only updates the location routine if the location routine output by the user device routine machine learning model is associated with an accuracy score that satisfies the accuracy score threshold. This ensures that the new location routine is accurate. If the updated location routine is not accurate, then the location analysis engine 208 may pause operations that involve the location routine. That is, the location analysis engine 208 may not evaluate whether deviation conditions are satisfied until the location routine is determined to be accurate. This helps prevent false positives for deviation events.

### Example Operations of the User Device

Turning now to FIG. 8, example operations may be performed by any one of the user devices 106A-106N, which may in turn be embodied by the apparatus 250, which is shown and described in connection with FIG. 2B. To perform the operations described below, the apparatus 250 may utilize one or more of the processor 252, the memory 254, the communications hardware 256, the location engine 258, and/or any combination thereof.

As shown in operation 802, the apparatus 250 includes means, such as the communications hardware 206 or the like for receiving user permission for location data tracking. In some embodiments, the communications hardware 206 may receive user input from the user that enables apparatus 250 to share its location with one or more other devices, such as location services system 102. In some embodiments, the communications hardware 206 may receive user input within a respective mobile application, such as a mobile application associated with the location services system 102. For example, the customer may accept or reject the request for location tracking within the mobile application. If the customer accepts the request for location data tracking, the apparatus 250 may be enabled to share location data with the location services system 102. In some embodiments, the processor 252 may update this configuration in an associated memory, such as memory 254. In some embodiments, this may cause the communications hardware 256 to share location data with the location services system 102 at periodic intervals and/or in response to particular events if configured by the user.

As shown in operation 804, the apparatus 250 may include means, such as the location engine 258 or the like, for capturing a current location. In various embodiments, the user device 106A may capture a current location, which may be the current location of the apparatus 250 For example, the location analysis engine 258, may capture GPS data, IP addresses, or the like at associated times.

As shown in operation 806, the apparatus 250 may include means, such as communications hardware 256 or the like for providing the current location. In various embodiments, the communications hardware 256 may provide the captured current location securely, via the communications network 104, to the location services system 102.

FIGS. 3-8 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special-purpose hardware-based computing devices or combinations of special-purpose hardware and software instructions that perform the specified functions.

In some embodiments, some of the operations described above in connection with FIGS. 3-8 may be modified or further amplified. Furthermore, in some embodiments, additional optional operations may be included. Modifications, amplifications, or additions to the operations above may be performed in any order and in any combination.

### Conclusion

As described above, example embodiments provide methods and apparatuses that enable automatic detection of deviations in user device data that may be indicative of changes in customer information. Example embodiments provide a technically advanced, automated approach to customer account management by leveraging real-time location analysis and predictive modeling to detect a deviation event that may indicate changes in customer information and/or potentially fraudulent activity. By dynamically updating customer records, enforcing intelligent customer account restrictions, and reducing reliance on customer engagement, example embodiments enhance customer information accuracy, fraud prevention, and regulatory compliance while minimizing operational overhead. Thus, example embodiments lead to greater system efficiency, minimize security risks, and ensure seamless customer interactions. Furthermore, example embodiments may adapt and refine the location routine for the user device over time using the user device routine machine learning model, thereby improving the location routine accuracy and reducing false positives.

Moreover, embodiments described herein may further improve the detection of potentially fraudulent activity and implement account restrictions to reduce the potential harm caused by fraud. Additionally, by automating the detection of potential changes in the collected customer information, targeted requests for updating customer information may be sent to the customer, reducing repetitive serialized requests for updating customer information sent on a time-based schedule (e.g., every six months). Finally, the collection and analysis of location data for the detection of customer deviations performed by example embodiments unlocks many potential new functions that have not historically been available, such as the ability to detect a change in employment that may have an effect on the services available to the customer.

As these examples all illustrate, example embodiments contemplated herein provide technical solutions that solve real-world problems faced during the collection and maintenance of accurate customer information. And while the maintenance of accurate customer information has been an issue for decades, the move to online services has made this problem significantly more acute, as the use of the customer information has decreased, maintaining correct customer information has become less of a priority for the customer and as such it is often overlooked. At the same time, the recently arising ubiquity of location data has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for dynamically adjusting institutional interactions with a customer based on location data, the method comprising:
receiving, by communications hardware, a location routine for a user device, wherein the location routine defines predicted locations for the user device in corresponding time windows;
receiving, by the communications hardware, a current location of the user device;
determining, by a location analysis engine and based on the current location and the location routine, whether a deviation condition for a candidate deviation event type is satisfied, wherein the deviation condition defines at least one of (a) a frequency of discrepancies between the current location of the user device and predicted locations over a time frame, (b) a deviation duration for a length of time the current location differs from one or more predicted locations, (c) a location type associated with the current location, (d) a maximum distance between the current location and a previous location, (e) a geographic threat assessment requirement for the current location, and (f) a transaction threshold for a predicted location;
in response to determining that the deviation condition for a candidate deviation event type is satisfied, detecting, by the location analysis engine, occurrence of a deviation event associated with a deviation event type; and
updating, by the location analysis engine and based on the deviation event type, a customer account associated with the user device, wherein updating the customer account comprises at least one of (a) applying an account restriction, and (b) modifying customer information within the customer account.

2. The method of claim 1, further comprising:
in response to detecting the occurrence of the deviation event and based on the deviation event type, applying, by the location analysis engine, the account restriction to the customer account;
providing, by the communications hardware, an authentication request to the user device associated with the customer account, wherein the authentication request prompts the customer to confirm a customer identity;
receiving, by the communications hardware, an authentication response from the user device;
authenticating, by the location analysis engine, the customer based on the authentication response; and
in response to successfully authenticating the customer, removing, by the location analysis engine, the account restriction from the customer account.

3. The method of claim 1, further comprising:
determining, by the location analysis engine, a discrepancy between the current location and a predicted location for a corresponding time window;
determining, by the location analysis engine, whether the discrepancy causes a deviation duration threshold for an out-of-bounds travel deviation event type to be exceeded; and
in response to determining that the discrepancy caused the deviation duration threshold to be exceeded, determining, by the location analysis engine, that the deviation condition for the out-of-bounds travel deviation event type is satisfied.

4. The method of claim 1, further comprising:
determining, by the location analysis engine, a distance between the current location and previous location of the user device, wherein the previous location is associated with a first time stamp and the current location is associated with a second time stamp;
determining, by the location analysis engine, a delta time between the first time stamp and the second time stamp;
determining, by the location analysis engine and based on the delta time, a maximum distance;
determining, by the location analysis engine, whether the distance between the current location and the previous location exceeds the maximum distance; and
in response to determining that the distance exceeds the maximum distance, determining, by the location analysis engine, that the deviation condition for a rapid location change deviation event type is satisfied.

5. The method of claim 1, further comprising:
determining, by the location analysis engine, whether the current location is associated with a flag, wherein the flag is assigned to a location that is restricted, blacklisted, or considered high risk; and
in response to determining that the current location is associated with a flag, determining, by the location analysis engine, that the deviation condition for a high-risk location deviation event is satisfied.

6. The method of claim 1, further comprising:
receiving, by the communications hardware, a transaction request associated with the customer account, wherein the transaction request comprises a transaction amount;
determining, by the location analysis engine, that the current location corresponds to a predicted location;
extracting, by the location analysis engine, at least one of an average transaction amount and a transaction range for the predicted location from the location routine;
determining, by the location analysis engine, a transaction threshold for the predicted location based on at least one of the average transaction amount and the transaction range;
determining, by the location analysis engine, whether the transaction amount satisfies the transaction threshold; and
in response to determining that the transaction amount fails to satisfy the transaction threshold, determining, by the location analysis engine, that the deviation condition for a customer account activity deviation event is satisfied.

7. The method of claim 1, further comprising:
determining, by the location analysis engine, a discrepancy between the current location and a predicted location for a corresponding time window;
determining, by the location analysis engine, whether the current location corresponds to a residential location type;
determining, by the location analysis engine, whether the discrepancy causes a threshold number of discrepancies for a residential relocation deviation event type to be exceeded; and
in response to determining that the current location is a residential location and the discrepancy exceeds the threshold number of discrepancies, determining, by the location analysis engine, that the deviation condition for the residential relocation deviation event type is satisfied.

8. The method of claim 7, further comprising:
providing, by the communications hardware, a residential address confirmation request to the user device;
receiving, by the communications hardware, a residential address confirmation response from the user device; and
in response to determining that the residential address confirmation response verifies the current location as a new residential address of the customer, updating, by the location analysis engine, the customer account to designate the current location as a residential address.

9. The method of claim 1, further comprising:
determining, by the location analysis engine, a discrepancy between the current location and a predicted location for a corresponding time window;
determining, by the location analysis engine, whether the current location corresponds to a commercial location type;
determining, by the location analysis engine, whether the discrepancy causes a threshold number of discrepancies for a workplace change deviation event type to be exceeded; and
in response to determining that the current location is a commercial location and the discrepancy exceeds the threshold number of discrepancies, determining, by the location analysis engine, that the deviation condition for the workplace change deviation event type is satisfied.

10. The method of claim 9, further comprising:
providing, by the communications hardware, a workplace confirmation request to the user device;
receiving, by the communications hardware, a workplace confirmation response from the user device; and
in response to determining that the workplace confirmation response verifies the current location as a new workplace address of the customer, updating, by the location analysis engine, the customer account to designate the current location as a workplace address.

11. The method of claim 1, further comprising:
receiving, by the communications hardware, an updated current location from the user device;
determining, by the location analysis engine, that the current location for the customer corresponds to a predicted location for a corresponding time frame; and
in response to determining that the current location corresponds to a trusted location, removing, by the location analysis engine, the account restriction from the customer account.

12. The method of claim 1, further comprising:
receiving, by the communications hardware, a plurality of location data from the user device; and
training, by a training engine, a user device routine machine learning model using the plurality of location data, wherein the user device routine machine learning model is used to generate the location routine.

13. The method of claim 1, further comprising:
generating, by the location analysis engine, an accuracy score for the location routine for the user device, wherein the accuracy score is a representation of predictive accuracy of the location routine for a plurality of location data;
in response to determining that the accuracy score fails to satisfy an accuracy score threshold, requesting, by the communications hardware, a second plurality of location data from the user device;
receiving, by the communications hardware, the second plurality of location data; and
retraining, by a training engine, a user device routine machine learning model using the second plurality of location data.

14. The method of claim 1, wherein the account restriction is one or more of a temporary spending limit, a customer account activity block, a termination of all active digital sessions, an additional authentication requirement, an outgoing transfer limit, and a ban on a payment method.

15. An apparatus for dynamically adjusting institutional interactions with a customer based on location data, the apparatus comprising:
communications hardware configured to:
receive a location routine for a user device, wherein the location routine defines predicted locations for the user device in corresponding time windows, and
receive a current location of the user device;
location analysis engine configured to:
determine, based on the current location and the location routine, whether a deviation condition for a candidate deviation event type is satisfied, wherein the deviation condition defines at least one of (a) a frequency of discrepancies between the current location of the user device and predicted locations over a time frame, (b) a deviation duration for a length of time the current location differs from one or more predicted locations, (c) a location type associated with the current location, (d) a maximum distance between the current location and a previous location, (e) a geographic threat assessment requirement for the current location, and (f) a transaction threshold for a predicted location,
in response to determining that the deviation condition for a candidate deviation event type is satisfied, detect occurrence of a deviation event associated with a deviation event type, and
update, based on the deviation event type, a customer account associated with the user device, wherein updating the customer account comprises at least one of (a) applying an account restriction, and (b) modifying customer information within the customer account.

16. The apparatus of claim 15, wherein the location analysis engine is further configured to, in response to detecting the occurrence of the deviation event and based on the deviation event type, apply the account restriction to the customer account,
wherein the communications hardware is further configured to:
provide an authentication request to the user device associated with the customer account, wherein the authentication request prompts the customer to confirm a customer identity; and
receiving an authentication response from the user device,
wherein the location analysis engine is further configured to:
authenticate the customer based on the authentication response; and
in response to successfully authenticating customer, remove the account restriction from the customer account.

17. The apparatus of claim 15, wherein the location analysis engine is further configured to:
determine a discrepancy between the current location and a predicted location for a corresponding time window;
determine whether the discrepancy causes a deviation duration threshold for an out-of-bounds travel deviation event type to be exceeded; and
in response to determining that the discrepancy caused the deviation duration threshold to be exceeded, determine that the deviation condition for the out-of-bounds travel deviation event type is satisfied.

18. The apparatus of claim 15, wherein the location analysis engine is further configured to:
determine a distance between the current location and previous location of the user device, wherein the previous location is associated with a first time stamp and the current location is associated with a second time stamp;
determine a delta time between the first time stamp and the second time stamp;
determine, based on the delta time, a maximum distance;
determine whether the distance between the current location and the previous location exceeds the maximum distance; and
in response to determining that the distance exceeds the maximum distance, determine that the deviation condition for a rapid location change deviation event type is satisfied.

19. The apparatus of claim 15, wherein the location analysis engine is further configured to:
determine whether the current location is associated with a flag, wherein the flag is assigned to a location that is restricted, blacklisted, or considered high risk; and
in response to determining that the current location is associated with a flag, determine that the deviation condition for a high-risk location deviation event is satisfied.

20. A computer program product for dynamically adjusting institutional interactions with a customer based on location data, the computer program product comprising at least one non-transitory computer-readable storage medium storing software instructions that, when executed, cause an apparatus to:
receive a location routine for a user device, wherein the location routine defines predicted locations for the user device in corresponding time windows;
receive a current location of the user device;
determine, based on the current location and the location routine, whether a deviation condition for a candidate deviation event type is satisfied, wherein the deviation condition defines at least one of (a) a frequency of discrepancies between the current location of the user device and predicted locations over a time frame, (b) a deviation duration for a length of time the current location differs from one or more predicted locations, (c) a location type associated with the current location, (d) a maximum distance between the current location and a previous location, (e) a geographic threat assessment requirement for the current location, and (f) a transaction threshold for a predicted location;
in response to determining that the deviation condition for a candidate deviation event type is satisfied, detect the occurrence of a deviation event associated with a deviation event type; and
update, based on the deviation event type, a customer account associated with the user device, wherein updating the customer account comprises at least one of (a) applying an account restriction, and (b) modifying customer information within the customer account.
